(19) United States
(12) Patent Application Publication
(10) Pub. No.: US 2017/0306277 A1
(43) Pub. Date: Oct. 26, 2017

(54) Fermentation Vessel

(71) Applicant: Benjamin Thaddeus Fisco, Portland, OR (US)

(72) Inventor: Benjamin Thaddeus Fisco, Portland, OR (US)

(21) Appl. No.: 15/495,964

(22) Filed: Apr. 24, 2017

Related U.S. Application Data
(60) Provisional application No. 62/326,601, filed on Apr. 22, 2016.

(51) Int. Cl. C12H 1/22; G05B 15/02; C12G 3/07

(52) U.S. Cl. CPC C12H 1/22; C12G 3/065; G05B 15/02

(57) ABSTRACT

An economical, durable, possible multi-use fermentation vessel formed of a base supporting a sidewall made with a first material and a top made with a more durable second material. The base may be formed of a durable material and downwardly sloping towards a drain to facilitate cleaning. Sensors in communication with a computer system may sense one or more physical properties of the liquid within the vessel, and the computer system may modulate fermentation properties such as temperature, pressure and pH within the vessel as needed to optimize the fermentation process. The vessel may be used as a stand-alone foeder vessel, whirlpool vessel or kettle sour vessel or be used as a multi-use combination of two or more of these vessels.

### CROSS REFERENCE TO RELATED APPLICATION

This application claims priority to U.S. provisional patent application Ser. No. 62/326,601 filed on Apr. 22, 2016, the disclosure of which is hereby incorporated by reference.

### FIELD OF THE INVENTION

The present invention relates to fermentation vessels such as foeder vessels, whirlpool vessels and kettle sour vessels used primarily in the production of beer and the like.

### BACKGROUND

Three vessels commonly used in the production of beer and the like are a foeder vessel, which is pronounced “FOOD-er”, a whirlpool vessel, and a kettle sour vessel. Each of these vessels is discussed in greater detail below.

Foeder Vessels

A foeder is a barrel-type, wood vessel commonly used in the fermentation and aging of wine and the like. More recently, foeders have been used to facilitate the production of beer. Foeders limit the ingress of oxygen into the wine and beer, and they allow for the easy supervision of the product during the fermentation process with the addition of a tasting valve. The wood can also impart unique flavors to the final product.

A high beer to wood ratio associated with having a large foeder allows the beer to mature and develop gradually. Producing the beer in smaller barrels may progress more quickly, thereby leading to acidification before the beer is fully developed. Moreover, larger foeders allow for greater capacity compared to smaller footprint barrels. Accordingly, because the product is coming from one large vessel, it is easier to produce a more consistent and reproducible product.

In a traditional oak barrel construction form, oak staves are fit and held tightly together with steel bands hammered into place to form the overall barrel structure. The foeder typically includes the previously mentioned staves and hoops assembled to form watertight sides. At each end, boards are typically fitted or joined to the sides to form a top and a bottom of the foeder. A unique feature of a foeder type of barrel is that it may include one or more access ports. The traditional construction is typically all wood, typically oak, with steel or other material manways or ports opening into the barrel at the top and or side that allow access to the interior of the foeder.

The oak in the foeder, once saturated, swells and tends to create a leak proof vessel which has certain characteristics that are sought after by vintners, brewers, and other people involved in fermentation sciences. For example, it is desirable that the foeder not leak, and that it is sealed against the intrusion of outside air (oxygen) that may interfere with the fermentation process.

The traditional foeder design has several drawbacks, including:

The top part of the foeder including the boards that make up the top always must be kept moist or saturated or the wood will dry out. Similarly, the manways in the side and top of the foeder tend to be prone to leakage and often require maintenance. If the wood of the foeder is allowed to dry, and contract, the area around the manways may leak once put back into use. In such a desiccated condition, air can enter the vessel causing the preferred anaerobic process of fermentation to become exposed to air. The result is that the product of fermentation becomes acetic and turns to vinegar.

Like the top, the bottom of the foeder is comprised of several pieces of wood joined together to make a leak proof “floor.” The bottom of the foeder is difficult to clean, and cleaning must be done manually by a worker physically entering the foeder to clean it after each use. This can be a dangerous and difficult operation. Also, the bottom of a traditional foeder is flat in construction so that precipitate tends to be distributed across the entire bottom surface of the foeder.

Other drawbacks of a traditional foeder include the fact that the wood ages and deteriorates over time and the joints tend to become loose thereby prematurely limiting the useful life of the foeder. Their designs also require them to be at the mercy of the ambient pressure and temperature, and their related pressure and temperature gradients, of the location in which they are placed. Pressure and temperature and their related gradients can affect the quality and taste of the product produced, and they can unduly slow the time it takes to precipitate the fermentation medium and prepare the foeder for the next fermentation cycle.

Whirlpool Vessels

In large brewing processes, whirlpool vessels tend to be stand-alone devices that are used to separate solid or semi-solid matter from liquids at temperatures very close to boiling point. In general, wort is pumped into the whirlpool vessel at rapid velocity to cause the wort to start spinning like a whirlpool. Then the wort is allowed to stand for an additional 20 minutes or so to allow the hops and trub to form a compact trub/hop pile in the center of the vessel. The wort is then easily separated from the pile by pumping it out of an outlet located on the side of the whirlpool vessel.

At high elevation, liquids boil at lower temperatures due to lower atmospheric pressure. The typical process for whirlpooling and transferring of liquids to and from the whirlpool vessel is to pump the liquid. At high elevation, the lower atmospheric pressure causes the liquid to boil at the inlet of the pump as the pump exerts a negative pressure or suction within the conduit delivering the liquid to the pump. The boiling of liquid as it enters the pump aerates the liquid—which is undesirable. It also cavitates the pump and can significantly slow the transfer of the liquids from the vessel.

Kettle Sour Vessels

Two different techniques can be used to produce a sour-tasting beer: kettling and aging. Ketting is much quicker and less expensive to make. Aging is an age-old tradition that involves careful production, long periods of fermentation and use of bacteria or wild yeast that if left unchecked can contaminate other beers. In quick-style souring, the beer can be soured during the mashing process when lactobacillus bacteria eat the sugars and converts them to acids to produce the sought-after sour flavor. It also can be soured in the boil kettle before the heat is turned up and the bacteria is killed off or pasteurized. The latter process is called kettle souring, and the vessel used is called a kettle sour vessel.

Maintaining constant desirable pressure and temperature within the kettle sour vessel during the kettle souring process is desirable to produce consistent beer with the best flavor.

### SUMMARY

Thus, there remains a need for an economical, durable, possible multi-use fermentation vessel able to overcome these known problems with existing fermentation vessels. The present invention fulfills these needs and others as described and claimed herein.

In one disclosed embodiment, the fermentation vessel is formed of a base supporting a sidewall made with a first material and a top made with a more durable second material. The base may be formed of a durable material and downwardly sloping towards a drain to facilitate cleaning. Sensors in communication with a computer system may sense one or more physical properties of the liquid within the vessel, and the computer system may modulate fermentation properties such as temperature, pressure and pH within the vessel as needed to optimize the fermentation process. The vessel may be used as a stand-alone foeder vessel, whirlpool vessel or kettle sour vessel or be used as a multi-use combination of two or more of these vessels.

These and other objects of the inventions are set forth in more detail in the following description and claims.

### FIGURE DESCRIPTIONS

The foregoing Summary and the following Detailed Description will be better understood when read in conjunction with the accompanying figures.

FIG. 1 is a front plan view of a fermentation vessel in accordance with an embodiment of the present invention.

FIG. 2 is a side view of the fermentation vessel of FIG. 1.

FIG. 3 is a tope view of the fermentation vessel of FIG. 1.

FIG. 4 is a cross-sectional view of the fermentation vessel of FIG. 1 taken along line 4-4 of FIG. 3.

FIG. 5 in an enlarged, fragmentary view of a portion of the cross-sectional view of the fermentation vessel of FIG. 4.

### DETAILED DESCRIPTION

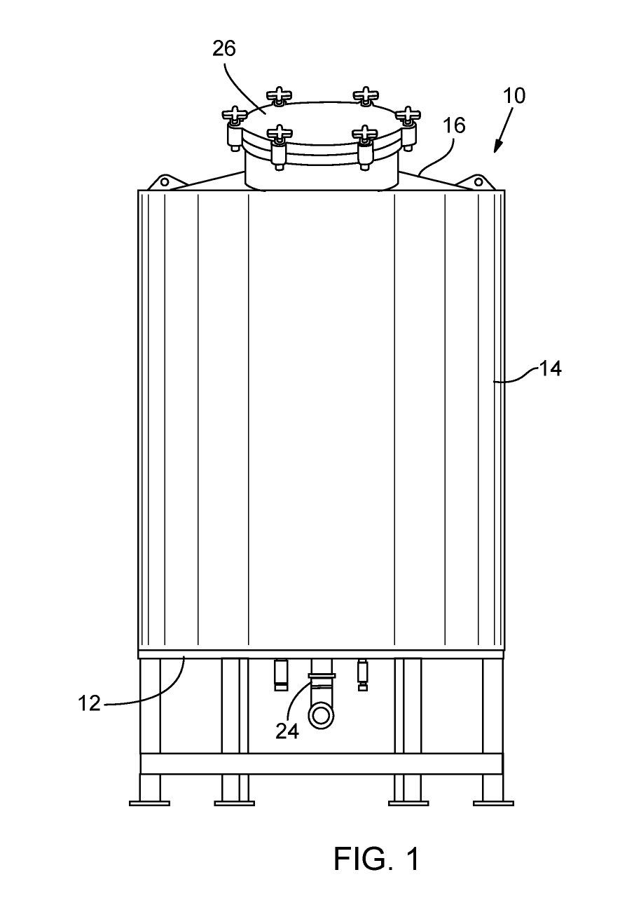

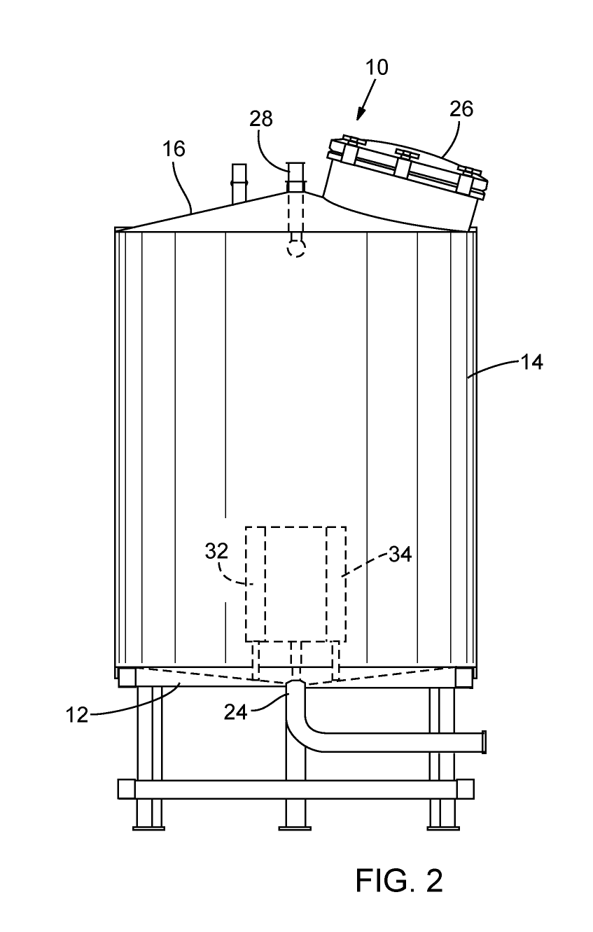

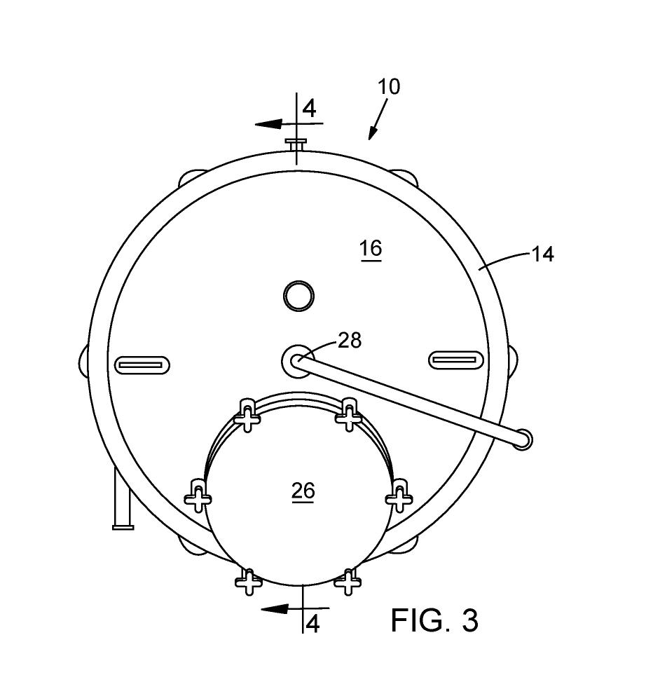

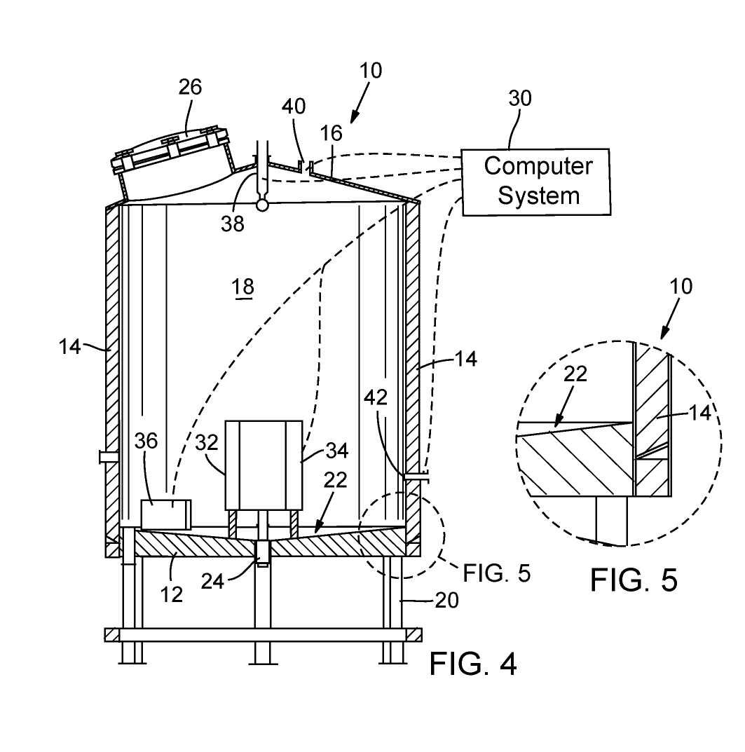

An optimized fermentation vessel 10 is shown in FIGS. 1-5. In general, the vessel 10 has a bottom 12, supporting a sidewall 14, and a top 16 positioned on top of the sidewall 13 to form a chamber 18 (FIG. 4) for receiving and fermenting liquid therein. The top 16 and bottom 12 are preferably monolithic structures constructed of durable materials such as stainless steel, concrete, plastic or the like. More preferably, the top 16, sidewall 14, and bottom 12 seal the chamber 18 to allow the chamber 18 to be both watertight and pressurized as needed.

The sidewall 14 may be constructed with traditional foeder materials such as wood or the like, or it may also be formed with more durable materials such as stainless steel, concrete, plastic or the like for use in other fermenting applications.

The bottom 12 may be flat bottomed or as best shown in FIG. 4 and more preferably, the bottom 12 can have a slight conical bevel 22 built into it for drainage. A center or offset drain 24 at the bottom of the conical surface allows for improved drainage and cleaning ability.

The top 16 may include one or more access ports 28 that are sealable. One port 26 can be sized to allow a person to enter therethrough to facilitate cleaning.

Other ports 28 can allow liquids and/or a pressure source to be applied to the chamber as needed.

The vessel 10 preferably rests on a stand 20 sized and shaped to support the vessel 10 when filled with liquid.

If desired, a heat source 32 and/or cooling element 34 may be operably positioned within or around the chamber 18 to heat and/or cool liquid within the chamber as needed. The heat source 32 and/or cooling element 34 may be manually controlled by an operator as needed. More preferably, these elements are in communication with a computer system 30 that adjusts the temperature as needed based on predetermined criteria.

If desired, a pressure source 38 may be operably secured to the fermentation vessel 10 for pressurizing the chamber. The advent of pressurization allows for the tank to be put under positive pressure with a gas or combination of gasses selected by the operator that allow for optimization of the environment inside the tank with regard to fermentation. The pressurization may be manually controlled by an operate as needed by modulating one or more pressure relief valves 40 and the inlet pressurization source 38. More preferably, these valves and the pressurization source are in communication with the computer system 30 that adjusts the pressure as needed based on predetermined criteria.

One or more sensors 42 for sensing physical properties such as temperature, pH, pressure and the like may be operably positioned with the chamber 18 to allow for real-time data collecting of the liquid within the chamber. These sensors 42 may be in communication with visual displays readable by an operator, or more preferably, are in communication with the computer system 30.

The predetermined criteria used by the computer system 30 to modulate temperature within the chamber 18 can be based on the detected data provided by the sensors.

If desired, an agitator 36 or internal pumping structure may be provided for stirring the liquid contents in the chamber to create a desired whirlpool effect.

The agitator may be manually activated by an operator as needed, or it can be in communication with the computer system 30 and operated based on predetermined criteria.

Preferably, a plurality of sensors are provided and in communication with the computer system each sensor spaced apart from the other, and the computer system includes control logic for optimizing and selecting the information obtained by the sensors. For example, three temperature sensors may be provided, and the system will flag an operator is one of the sensors reads more than 2 degrees off from the other two. More preferably, the sensors are positioned and mounted so as to be easily serviced and replaced without requiring emptying the chamber.

Having described the preferred elements of the fermentation vessel, it can be appreciated that not all of the described elements need be provided to use the vessel effectively in a variety of different activities used to produce beer and the like. Exemplar uses of the vessel are described below. While the inventions may be constructed as separate standalone inventions, it is important to also note that they may also be combined in a single system.

Foeder Vessel

The vessel 10 may be used to provide a foeder with improved maintenance and brewing/fermenting characteristics. It can be appreciated that the disclosed combination of elements allows for a foeder design that allows for easier cleaning of the interior, and it also provides better sealing of the foeder to aid in fermentation and prevent spoilage of the beverage being fermented. Also, the example described herein may include a temperature regulation mechanism, and allow for pressurization of the vessel. A final benefit of Applicant's invention is that it tends to have a longer service life than current foeder designs.

The maintaining of optimal temperatures may be desired in the fermentation process. The traditional foeder has no integrated temperature regulation either for heating or cooling incorporated into the design. It is for all practical purposes simply a barrel. Once fermentation is complete, a long process of waiting is undertaken while the fermentation medium that has been active in fermentation precipitates from the liquid and settles in the bottom of the foeder. The addition of a cooling mechanism into the liquid will tend to accelerate the precipitation process.

The new foeder design eliminates desiccation of the top and bottom. Such tops and bottoms allow for a manway to be constructed into the top of the foeder. And a flat or conical bottom may be constructed into the bottom of the new foeder, which aids in cleaning. In alternative examples, a clean out or wash out port may be provided. A conical design may or may not be added to the bottom of the foeder—depending upon preference. If a conical design is employed, an ultimate drain may be installed to greatly improve the new foeder vessel drainage.

Other advantages of the new design are that the top of the foeder no longer needs to be saturated or wetted to maintain a leak proof condition. The bottom of the foeder can be cleaned with a wash or clean in place operation so that man entry is no longer required to clean the vessel. In the preferred example, the bottom of the foeder will have a slight conical bevel built into it for drainage.

In the new design the side manway may or may not be incorporated. The new design makes the need for the side manway less critical, or irrelevant.

The new design may incorporate a heating and cooling element inside of the foeder. The element may be submerged into the product being fermented and monitored either manually or automatically to maintain optimal or near optimal temperatures within the foeder. The element may be powered by electricity, solar thermal power, steam, or a similar heating medium. The accurate maintenance of optimal or near optimal fermentation temperature within the foeder is a new design.

At the completion of fermentation, a foeder has traditionally needed to settle over a relatively long period of time. The new design with the inclusion of a cooling element within the foeder will cause the catalyst of fermentation to precipitate from solution. This saves time and allows for consistency and better control of the process.

The improved foeder may be equipped with an automated, semi-automated or manual control system with integrated temperature control regulated manually, semi automatically or fully automatically as may be desired. It may also be equipped without integrated temperature control. Controls, if so equipped, can be analog, digital, and any variation through a full complete PLC integrated touch screen. Temperature control can be on board, integrated or modular. The temperature control medium can be steam, glycol, oil, electric direct or indirect, solar or any suitable medium. The control system may integrate monitoring and analysis of the fermentation process. The monitoring and analysis of the fermentation process by the system may cause the control system to automatically react and change the fermentation regime to optimize the fermentation process.

The improved foeder has an increased service life. The use of non-wood tops and bottoms allow the foeder to be rebuilt with new wood, or new varieties of wood to be used with one reusable set of top and bottom assemblies.

High and Low Elevation Combination Whirlpool/Kettle Sour Vessel

This new vessel can also serve multiple other purposes in brewing operations. For example, it may serve as either a stand-alone whirlpool vessel or kettle sour vessel, or more preferably, be used as both a whirlpool vessel and a kettle sour vessel.

When the vessel is used as a whirlpool, it can be used in low elevation applications and revolutionizes the whirlpool and knock out or liquid transfer and cooling process at high elevations. The solution offered with this high elevation whirlpool vessel is to fabricate the vessel so that it can hold pressure, thus raising the apparent atmospheric pressure within the vessel and conduit conducting liquids to the pump, thereby eliminating the need for a pump or in case of utilizing a pump, eliminating the re-boil of liquid at the pump inlet. It should be noted that pressure may be used in place of or in conjunction with a pump to transfer the fluid through the conduit and pump. In either case, cavitation and aeration of the liquid is greatly reduced, and the process of moving the liquid through the cooling apparatus employed in the system is greatly streamlined and improved from the standpoint of process and time efficiency.

The vessel can also serve as a super insulated kettle sour vessel that has integrated temperature control regulated manually, semi automatically or fully automatically as may be desired. It may also be equipped without integrated temperature control. Controls, if so equipped, can be analog, digital, and any variation through a full complete PLC integrated touch screen. Temperature control can be on board, integrated or modular. The temperature control medium can be steam, glycol, oil, electric direct or indirect, solar or any suitable medium. The controls may be designed to integrate monitoring and analysis of the fermentation process. The monitoring and analysis of the fermentation process by the system may or may not cause the control system to automatically react and change the fermentation regime to optimize the fermentation process.

There currently exists no dedicated kettle sour vessel with controls for monitoring, adjusting and perfecting the temperature regime in the kettle sour fermentation process, and in no known instance does a kettle sour vessel employ the combination of pressure regulation and holding capacity with the ability to monitor and control temperature and pressure and or other characteristics of the fermentation process. The vessel may be equipped with on board or ancillary controls, which will accurately maintain optimal fermentation processes as selected by the operator. Any number of data points may be monitored and adjusted by the control system.

As an example, regarding the controls for the tank, a pH meter and additional controls may or may not be employed to allow for automated control of the tank. For instance, a pH meter may be installed that allows the operator to select a pH range that, when reached, will automatically cause the tank temperature control elements to optimize the conditioning environment within the tank. The level of automation in the controls can be from zero or no automation, to a completely automatic operation.

This vessel is also unique in that it combines the ability to whirlpool and kettle sour in a single apparatus, thus allowing flexibility and cost savings.

One skilled in the relevant art will recognize that numerous variations and modifications may be made to the configurations described above without departing from the scope of the present invention, as defined by the appended claims. For example,

What is claimed is:

1. A fermentation vessel comprising:
a base;
a sidewall produced with a first material, the sidewall operably secured to the base to form a seal therebetween; and
a top produced with a second material operably secured to the sidewall to form a seal therebetween and thereby define a substantially water and air tight chamber between the base, sidewall and top in which to receive liquid therein.

2. The fermentation vessel of claim 1, wherein the first material is wood and the second material is selected from the group consisting of stainless steel, concrete and plastic.

3. The fermentation vessel of claim 2, further including an access port operably secured to the top, said access portion having an open position in which a person may enter the chamber and a closed position in which the access portion is air and water tight against the top.

4. The fermentation vessel of claim 1, further including at least one sensor for detecting at least one physical characteristic of a liquid received within the chamber.

5. The fermentation vessel of claim 4, wherein the at least one physical characteristic of the liquid received within the chamber is selected from the group consisting of temperature, pressure and pH.

6. The fermentation vessel of claim 1, further including a heating element operably received within the chamber for modulating the temperature of the liquid within the chamber.

7. The fermentation vessel of claim 1, further including a cooling element operably received within the chamber for modulating the temperature of the liquid within the chamber.

8. The fermentation vessel of claim 1, further including a pressure source operably connected to the chamber for modulating the pressure within the chamber.

9. The fermentation vessel of claim 1, further including an agitator for stirring the liquid within the chamber to form a whirlpool.

10. The fermentation vessel of claim 1, wherein the base has an upper surface that is tapered downward toward a lower point.

11. The fermentation vessel of claim 9, further including a drain hole at the lower point.

12. The fermentation vessel of claim 1, further including:
a temperature sensor operably connected within the chamber to detect the temperature of a liquid within the chamber, said temperature sensor in communication with a computer system;
a heating element operably connected within the chamber for modulating the temperature of the liquid within the chamber, the heating element in communication with the computer system and activated by the computer system based on predetermined criteria including the detected temperature of the liquid within the chamber.

13. The fermentation vessel of claim 1, further including:
a pressure sensor operably connected within the chamber to detect the pressure within the chamber, said pressure sensor in communication with a computer system;
a pressure source connected within the chamber for modulating the pressure within the chamber, the pressure source in communication with the computer system and activated by the computer system based on predetermined criteria including the detected pressure within the chamber.

14. The fermentation vessel of claim 14, further including a pressure relief valve operably secured to the fermentation vessel and in communication with the computer system, the pressure relief valve activated by the computer system based on predetermined criteria including the detected pressure within the chamber.

15. The fermentation vessel of claim 1, further including a pH sensor operably connected within the chamber to detect the pH of a liquid within the chamber, said pH sensor in communication with a computer system;
a heating element operably connected within the chamber for modulating the temperature of the liquid within the chamber, the heating element in communication with the computer system and activated by the computer system based on predetermined criteria including the detected pH of the liquid within the chamber; and,
a pressure source connected within the chamber for modulating the pressure within the chamber, the pressure source in communication with the computer system and activated by the computer system based on predetermined criteria including the detected pH of the liquid within the chamber.

16. The fermentation vessel of claim 15, further including a pressure relief valve operably secured to the fermentation vessel and in communication with the computer system, the pressure relief valve activated by the computer system based on predetermined criteria including the detected pressure within the chamber.

17. The fermentation vessel of claim 16, further including an agitator for stirring the liquid within the chamber to form a whirlpool, wherein said agitator is in communication with the computer system and activated by the computer system based on predetermined criteria.

18. The fermentation vessel of claim 3, wherein the vessel forms a foeder.

19. The fermentation vessel of claim 6, wherein the vessel forms a kettle sour vessel.

20. The fermentation vessel of claim 15, wherein the vessel forms a combination whirlpool vessel and kettle sour vessel.
